(19) United States
(12) Patent Application Publication
(10) Pub. No.: US 2007/0043741 A1
(43) Pub. Date: Feb. 22, 2007

(54) A NOTE TAKING AND COURSE MANAGEMENT SYSTEM

(76) Inventor: Kenneth C Rydzewski, Lynn, MA (US)

Correspondence Address: ANTOINETTE G. GIUGLIANO, P.C., 390 SALEM STREET, LYNNFIELD, MA, 01940, US

(21) Appl. No.: 11/161,802

(22) Filed: Aug. 17, 2005

(51) Int. Cl. G06F 7/00

(52) U.S. Cl. 707/100

(57) ABSTRACT

The present invention relates to a course management system tailored for individuals with learning disabilities, special needs and/or organizational problems. The course management system includes a file folder that has first fastener attached to the inside region of the left side of the file folder; a second fastener attached to the inside region of the right side of the file folder; a first label having an identifier for the course title, name of professor, course number, class time and class location, the first label is attached to the file folder; a second label on the inside region of the left side of the folder to identify a location of papers received from the professor; and note taking paper, wherein the paper is marked with a header that indicates the day, date or both; and page number. The present invention also includes note taking paper, and methods for using the course management system.

### INCORPORATION BY REFERENCE

This application is related to U.S. Design application filed Aug. 17, 2005, concurrently herewith, entitled “Note Taking and Course Management” by Kenneth C. Rydzewski, Attorney Docket No.: 0029.0002-000, the entire teachings of which are incorporated herein by reference.

### BACKGROUND OF THE INVENTION

Children and individuals with learning disabilities, special needs or organizational weaknesses often have trouble organizing course material. Organizational problems can significantly compound a person's ability to learn and focus, especially when the individual has a learning disability. For example, individuals with a learning disability and/or organizational weaknesses might be distracted trying to remember which class(es) are scheduled that day, attempting to retrieve the course syllabus, wondering what homework is due, locating their last set of notes, and/or recalling what questions the user may have, instead of focusing on the lecture that is going on at the time. These organizational problems can frequently prevent or distract a person from concentrating on the material at hand, and become a substantial obstacle to the learning/retention process.

Hence a need exists to tailor a note taking system for persons with learning disabilities, special needs or organizational weaknesses. In particular, a need exists for a comprehensive note taking and course management system for persons with organizational issues.

### SUMMARY OF THE INVENTION

The present invention relates to a note taking and course management system for persons who find organizing course material to be an issue. The system includes a file folder, when open, having a first side and a second side, wherein the first and second sides each have an inside region, an outside region, a top and a bottom. The system also has a first fastener attached to the inside region of the first side of the file folder (e.g., located at the top); and a second fastener attached to the inside region of the second side of the file folder (e.g., located at the top). The course management system also includes a first label having a first identifier to specifically identify the course (e.g., course title, name of professor, course number, class time, class location, or combination thereof), wherein the first label is attached to the file folder. A second label is also included on the inside region of the first side of the folder to indicate a location of papers received from the professor. The course management system also includes note taking paper, wherein the paper is marked with a header that indicates the day, date, page number, or combination thereof. In one aspect of the present invention, the inside region of the first side of the folder has an additional label to mark a location for a course syllabus. The course management system can optionally include one or more sections or dividers for vocabulary, questions, homework assignments, miscellaneous, or any combination thereof. The specific labels described herein can be already attached by the manufacturer, or included separately e.g., on a sheet of paper, to be attached by the user. In one embodiment, the course management system has one or more tabs. The first label, in one aspect, is placed on the tab, or on front of the file folder. In yet another embodiment, the system of the present invention includes a pocket (e.g., a transparent pocket) for receiving a course syllabus. Such a pocket can be attached to the inside region of the first side of the file folder. The system of the present invention also contains, in some embodiments, a two-hole punch. Additionally, the system can be in electronic form.

The present invention embodies a file folder for use in managing a course, as described herein. The file folder, when open, has a first side and a second side, and the first and second sides each have an inside region, an outside region, a top and a bottom. The file folder has a first fastener attached to the inside region of the first side of the file folder; and a second fastener attached to the inside region of the second side of the file folder. The folder of the present invention further comprises a first label having a first identifier to specifically identify the course, wherein the first label is attached to the file folder; a second label on the inside region of the first side of the folder to indicate a location of papers received from the professor; and a third label on the inside region of the second side of the folder to mark a location of note taking paper.

In yet another embodiment, the present invention pertains to note taking paper. Note taking paper is of a suitable size for taking notes; and has a header positioned at the top of the paper that indicates the day, date, page number, or combination thereof. Such note taking paper is structured for integrating a note taking log with notes themselves.

The present invention additionally relates to methods for using a course management system. The methods include obtaining the course management system described herein, and keeping an integrated note taking log and note set (e.g., taking notes on the note taking paper by recording the day, date or both, number of pages, and notes, if any); and attaching papers received from a professor from the course with the first fastener. The methods also involve attaching, to the first fastener, the syllabus received from the professor as the top most document, and the integrated note taking log and note set to the second fastener.

Methods of making a course management system are also encompassed by the present invention. Such methods include marking or labeling the filed folder described herein with a first identifier for the course, and attaching a first fastener to the inside region of the first side of the file folder; and attaching a second fastener to the inside region of the second side of the file folder. The methods of making the course management system also involve marking or labeling the file folder with a second label on the inside region of the first side of the folder to indicate a location of papers received from the professor; and attaching note taking paper with the second fastener, wherein the paper is marked with a header that indicates the day, date, page number, or combination thereof. In one aspect, the methods further include inserting, into the file folder, one or more dividers, e.g., for vocabulary, questions, homework assignments, or combination thereof.

Advantages of the present invention include an organized and comprehensive note taking and course management system. Such a system is especially useful to persons with organizational issues and/or for persons with learning disabilities. The course management system allows a professor, a special education liaison, or parent to quickly and easily track where a student is having problems. The present invention provides a method for tracking and making use of the barrage of information and materials that are handed out to students for each course. Once the system is adopted, the user automatically knows where items go without having to think about it, and the system becomes routine. The system of the present invention is universal for all types of courses. The present invention greatly aids the user in organizing course material, so that the user can concentrate on learning the content of the course, instead of being distracted or disabled by organizational issues.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic of one embodiment showing the perspective view of the outside cover of the left side of a file folder of the course management system of the present invention.

FIG. 2 is a schematic of an embodiment showing the perspective view of the inside region of the left and right sides of a file folder of the course management system of the present invention.

FIG. 3 is a schematic of another embodiment showing the perspective view of the inside region of the left and right sides of a file folder of the course management system of the present invention.

FIG. 4 is another schematic of an embodiment showing the perspective view of additional dividers for vocabulary, homework and questions for a filed folder of the course management system of the present invention.

### DETAILED DESCRIPTION OF THE INVENTION

A description of preferred embodiments of the invention follows.

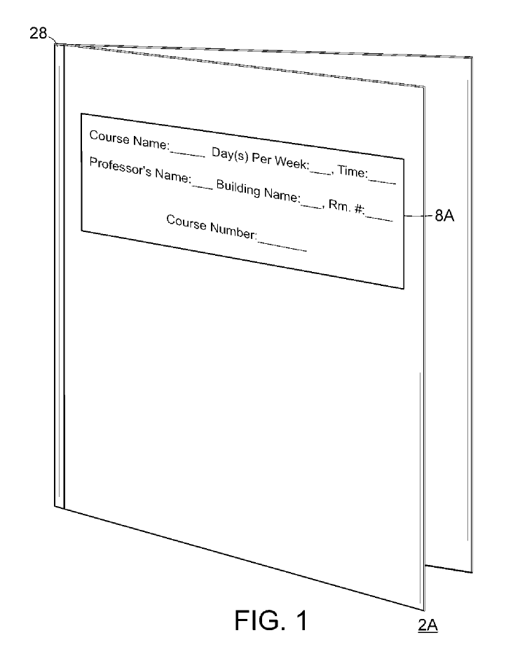

The present invention relates to a note taking and course management system that assists the user in organizing course material so that the user can focus on the class lecture. Referring to FIG. 1, file folder 2A shown in a partially closed position has label 8A. The course management system of the present invention is specifically designed to assist individuals with special needs and/or organizational issues in organizing course material. One aspect of the course management system that helps organize course information is a label, such as label 8A, that is specifically designed to breakdown the central elements of the course (e.g., identify the course). At the beginning of a semester, a student is often bombarded with a multitude of new and different facts about their environment, the courses, the campus, etc. Such a label serves as a reminder of who, where, and when to go to class, and it is quickly and easily referenced. Label 8A shows identifiers for the course name, the day(s) of the course, the time of the course, the professor's name, the location of the course (e.g., building name and room number), and the course number. Labels that specifically identify the course can have the identifiers shown in label 8A, or any combination thereof. Prior to the present invention, general file folders without a label or with a blank label do not guide or alert students with special needs or organizational issues to mark file folders with this particular information. When not directed, a student, especially one with organizational problems, often does not put all the necessary information about the course, including the day, and time of the class along with the location on the notebook for easy reference. When such information is not on the file folder, a student with organizational problems can easily forget what class(es) s/he has and when. Rather, the present invention directs the user to apply this information to the file folder by providing the specific course information needed and space for the user to fill it in. A user who may get easily confused or has forgotten which class or classes s/he has that particular day, simply has to look for file folders marked with that day of the week and instantly knows what classes s/he has, what time they are and where they will be held.

File folder 2A shown in FIG. 1 is a plastic folder, that is 9½″ wide from the spine to the opening, and 11¾″ long, made to fit 8.5″×11″ note taking paper, as further described herein. A number of various types of file folders can be used with the note taking and course management system of the present invention, and include for example, folders, binders, and notebooks. Any paper storing device can be used, including those known or developed in the future, so long as it can be organized with the methods described herein. The phrases “paper storing device” and “file folder” are used interchangeably herein. File folders can range in size so long as the folders accommodate note taking paper and materials received from the professor for the course. In particular, paper storing devices that can be used range in size from about 8.5″ in width (from spine to opening) to about 13″, and about 11.5″ to about 15″ in length (from top to bottom). The file folder can be made of several materials including paper, press board, plastic, or any other suitable material. Preferably, the material is thick enough or heavy weighted to be durable. In one embodiment, the file folder of the present invention is made from a durable plastic material. Any material can be used to make the file folder, so long as the material is durable and can be used to organize course work as described herein.

File folder 2A has spine 28. The spine can be durable, fixed and/or expandable. The spine can accommodate a thickness ranging from about 0.5″ to about 4″. Expandable spines can include those that have a series of folds (accordion style) that allow for expansion. The spine can be attached to the sides of the file folder, or integrated into the file folder. The spine can be a part of the folder or, it can be attached with glue, fasteners, staples, or any other suitable method, so long as the spine holds the sides of the file folder together. Preferably, the spine is durable, as are the sides of the file folder. Like the file folder, the spine can also be made from paper, press board, plastic, or other suitable materials.

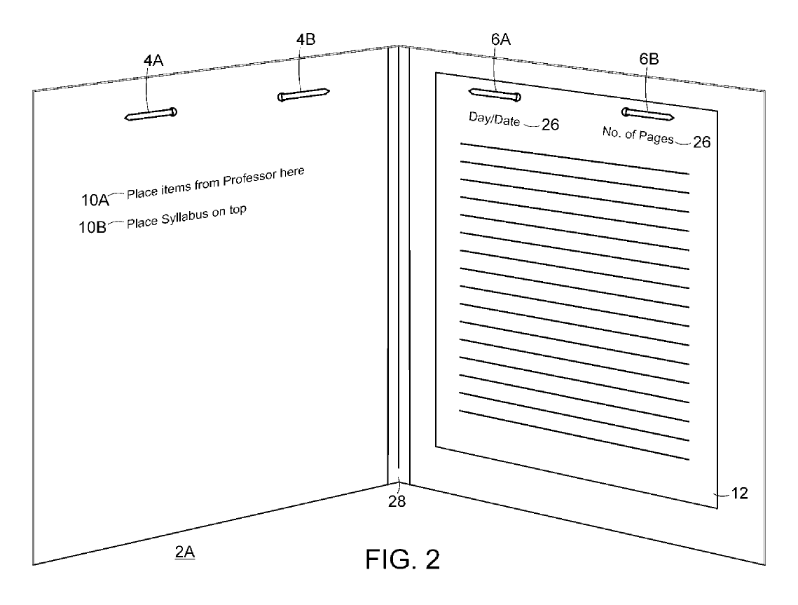

File folder 2A is shown in its open position in FIG. 2. In this embodiment, the left side of the file folder accommodates papers received from the professor for the course, including the syllabus, which is preferably placed as the top most document. Keeping the syllabus on top allows the user to make changes to the syllabus quickly and efficiently, without having to search for it. The professor may change deadlines at any given moment and the student should be in a position to be able to log the change immediately without having to dig through a binder, a bag, or a knapsack wasting valuable time. Even worse, if the student cannot locate the syllabus s/he might not remember to properly track the change or follow through on the assignment. For example, if the professor announces at the beginning of class that a test date will be changed, a student with special needs or organizational issues could spend several minutes just looking for the syllabus to record the change, and if it is not found, the user may forget the date all together, or write down in an unhelpful place, a place that would not easily alert the user on that day, or it may be lost entirely. Such a distraction can cause the user to lose his/her focus on all or some of the lecture. Another advantage for placing the syllabus on top is that the user can consult the syllabus before class to be sure that s/he is prepared for class that day (e.g., have appropriate homework in hand, prepared for a test or quiz, etc.). Having the syllabus in a readily available location also makes it easy to reference or to clarify a point about a paper or a project with the professor. Furthermore, if a student goes home and has a question about an assignment, paper, and/or project all s/he needs to do is to put a post-it or pencil in a notation to gain clarity on the very next lecture. An identifier, such as label 10B, directs the user to keep the syllabus on top of the stack of papers received from the professor. The identifier should be in clear lettering and conspicuous. An aspect of the invention includes separating the syllabus apart from the rest of the course material, or to keep the syllabus readily available. This can also be accomplished by having a separate divider for the syllabus, or having a special pocket (e.g., a transparent pocket) for the syllabus that can be maintained on top of a stack of papers received from the professor. The mechanism for keeping the syllabus readily available or separated away from other materials can be any mechanism that does so, and is aided by specifically identifying or labeling its location.

Another aspect of the invention includes a location for papers received from the professor. The location is identified by clear lettering. FIG. 2 shows label 10A, an identifier of the location of received papers. A file folder that does not have a specific location for papers received from the professor can often lead to a confusing situation for a user that has organizational challenges. For example, a user with organizational challenges tends to file papers, both those received and created by himself/herself, in one section, thereby mixing them up. When papers received and papers created by the user are filed in the same location, a person with organizational difficulties will spend an inordinate amount of time looking for a particular paper (e.g., his last set of notes, or the syllabus, etc.), instead of focusing on the lecture and taking notes. When a person with organizational difficulties, especially those with learning disabilities, spends time looking for the particular paper, s/he is not paying attention to the lecture at hand and can miss important information. As such, the file folder is marked with a label to identify the specific location for papers from the professor. The actual location (e.g., left side or right side) of the identifiers, such as an identifier for papers received by the professor, is not important, so long as there are specifically marked areas for the items or combination of items mentioned herein (e.g., the syllabus, notes taken, papers received from the professor, course identifiers, homework, questions, vocabulary). FIG. 2 shows a preferred embodiment with labels 10A and 10B, identifiers for the syllabus and items from the professor, on the left inside flap of the file folder. However, these items can be placed on the right inside flap instead, or as described herein, a pocket can be used for the syllabus and another specific location for the received papers. The present invention encompasses, in part, specific identified locations for the syllabus, papers received, and notes taken.

The papers received, notes taken, and other papers described herein are bound to the file folder by a means for attaching or fastening papers to a file folder, such as a fastener. A fastener can be any device that allows the user to attach and remove a paper or document with or without punched holes. Fasteners now known, or those later developed, can be used in the present invention. Examples of fasteners include bendable, prongs; latches; coiled spring fasteners; clips; rings; snaps; combinations thereof and the like. Fasteners can be made from a variety of material including metal, and plastic. They are preferably located horizontally at the top of one or more inside regions of the file folder, but can be located vertically at the outer or inner edges of the insides of the file folder. An example of the horizontal fastener is a 2-prong fastener, and an example of a vertical fastener is a file folder or binder with 3 rings or clip located on the inside center. FIG. 2 shows a first fastener, prongs 4A and 4B, on the left inside region of the file folder for attachment of papers received from the professor, and second fastener, prongs 6A and 6B, on the right inside of the file folder for attachment of notes taken.

FIG. 2 also shows file folder 2 having a right inside portion for securing note taking paper 12. When using the present invention, the student should be prepared to take good notes in every class and to log the day, date, and/or page number on every page as further described herein. In an embodiment, notes can be rotated so that the most current notes are on the top and the oldest notes are on the bottom of the pile of unused notebook paper. Below the notebook paper, and old notes, the student in one embodiment, can place all of the papers that belong to the student, to include term papers, outlines, or other assignments that either belong to the student or were submitted by the student to the professor. Alternatively, separate sections (e.g., dividers) for vocabulary, homework assignments, questions, etc. can be used, as further described herein.

Note taking paper 12 is specially formatted for individuals with organizational problems and/or learning disabilities. Note taking paper 12 has a header 26 labeled with the “Day/Date” and “Page No.” The note taking paper has at least two aspects, it allows the user to keep a log of notes, and it allows the user to take the actual notes. Note taking involves taking notes and creating a log in one document. The note taking procedure involves the student recording the day, date, or both, and the number of pages of notes, along with the actual notes. Even if the student does not take notes for a class, it is a point of discipline, for the student to log in his/her note taking each and every day when using an embodiment of the present invention. The user writes the day and date of the lecture, and the number of pages of the note set. Even for days when no notes are taken, the user indicates that on the log. When the note taking spills onto one or more pages, the log is labeled with the number of pages. For example, at one particular lecture, the user takes 2 pages of notes. The first page of notes contains a label with the day and date, and page 1. The second page of notes contains the day and date, and page 2. At the next lecture, the user indicates that particular day and date, and the number of pages of notes for that day, if any. The end result is a note taking log that has the user's notes included in a systematic fashion. The pages of the note taking paper are preferably kept in reverse chronological order. The Exemplification section shows some specific examples of the note taking log. Accordingly, an aspect of the invention is the note taking paper structured to guide the user to write the day, date, or both of the lecture, and the number of pages of notes taken for a particular lecture. In a specific embodiment, the note taking paper has a header stating “Day/Date” and “No. of Pages.” The exact wording is not important so long as the header indicates to the user to record a log as well as the notes in the same document.

Additionally, the paper can be modified to accommodate the type of fastener used, e.g., pre-punched with holes at the top to be used with a 2 pronged fastener, or pre-punched with holes along the side to be used with 3 ring fastener. The paper can be lined, (e.g., college-ruled) suitably for taking hand written notes, or not lined, e.g., for use with a printer. The size of the note taking paper should be large enough to take notes, and small enough to fit in a file folder. The paper can range in size from about 4″ to about 12″ in width, and about 6″ to 15″ in length.

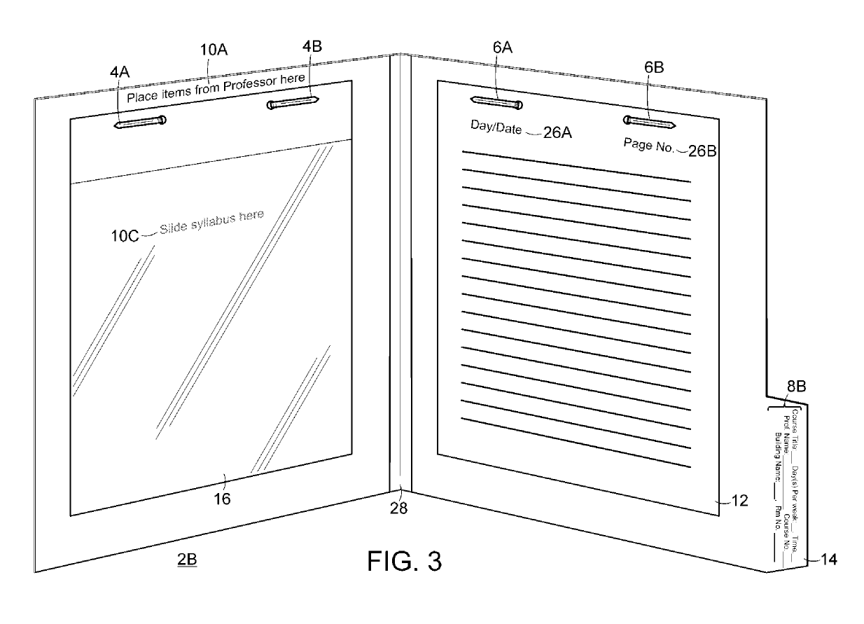

With respect to FIG. 3, another embodiment of the present invention is shown. File folder 2B, like file folder 2A, has specific identifiers for received papers, syllabus, items from professor, and note taking paper, but file folder 2B has pocket 16 for receiving the syllabus. Pocket 16 is transparent and can be kept on top so that the syllabus can be easily viewed by the user. Papers from the professor, as identified by label 10, are kept under pocket 16. Additionally, file folder 2B has tab 14 with identifying course information (e.g., course title, Days per week, time, professor's name, course number, building name, room number, or a combination thereof) on it. Like label 8A of file folder 2A, shown in FIG. 1, tab 14 has a label 8B with the same information on it, but in another visible place. The course management system of the present invention includes having identifying information on a tab, on the front of the file folder, or both.

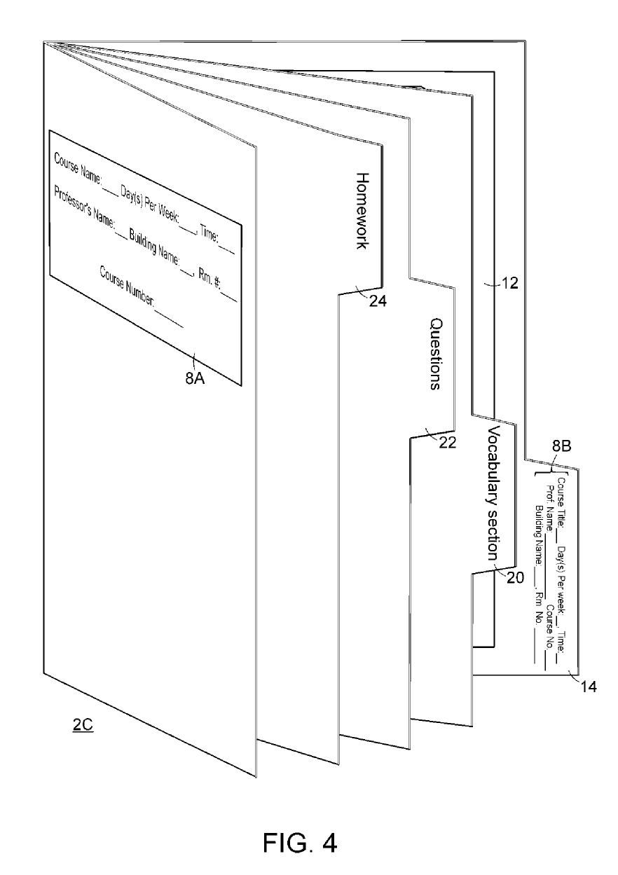

FIG. 4 shows yet another embodiment of the present invention. File folder 2C has four different built in dividers, the first of which is labeled with specific course information, as described herein. In this figure, divider 24 is a “Homework” divider, divider 22 is a “Questions” divider, and divider 20 is a “Vocabulary” divider. Examples of labels for additional dividers that can be used in any embodiment include “Scientific Laboratory Work,” “Registration Information,” “Financial Aid,” “Personal Information” (e.g., dormitory, roommate name, phone number, email address, etc.). For example, with a vocabulary divider, the student will not only be able to capture/isolate an unfamiliar word(s) or highly specialized concepts, but s/he will be free to move forward with the lesson and obtain clarification at a future time. The student will not lose sight of the word(s)/concept or get bogged down by trying to invent a place to put/log it. The material is not lost in the shuffle. Another embodiment of the present invention includes a file folder sold with one or more pre-made label sheet, as described herein. The labels needed by the user can be selected and attached to the file folder.

Additional dividers can be used and specifically labeled, and will vary depending on the type of course and/or user. For example, for a laboratory course, an additional divider labeled for experiments or laboratory work can be used, and for a writing course, the present invention can include a divider labeled for grammar or written work products (e.g., short stories, poems, etc.). Other dividers can include ones for sample and graded exams, research, or simply a miscellaneous divider as a catch-all. The course management system of the present invention can be tailored to suit the specific course type and/or work to be done. Such dividers are preferably built into the file folder, but can also be removably attached. Built-in dividers can be attached at the spine, or by a fastener, as described herein. The dividers serve to help keep various types of papers often used by a student in a specific area, so that when a person, especially one with organization issues, attempts to locate the paper, it can be done with ease.

The course management system of the present invention can be made from obtaining a file folder, and labeling the file folder as described herein. Fasteners can be purchased and attached to the file folder, and areas for papers can be specifically marked, as described herein. The note taking paper can be made from obtaining paper and placing a heading across the top, also as described herein, and punching holes in the paper so that it can be attached to the file folder in its specific location. Paper, file folders, fasteners can be obtained from an office supply store, such as Staples or Officemax.

The present invention can be sold with software or templates to generate the labels described herein. The present invention can also be done in electronic form, via the use of software. Software can be designed to organize electronic file folders in the same fashion, as described herein, but notes are taken on a computer, such as a laptop.

The course management system of the present invention, can include a series or plurality of file folders, as described herein, one for each subject or course. The system can further include a separate file folder for administrative materials, such as financial aid forms, registrar forms, official course printouts, a campus map, phone numbers, and the like. Such a folder can be organized as described herein.

Exemplification: Course Management System

The course management system of the present invention was made using a Standard Manila Letter Size File Folders (one per subject); Prong Fasteners 2″ (51 mm) capacity (two per folder), and Standard Two-Hole Puncher (complete with measuring rule). The file folders were punched with a two-hole punch, and the ruler on the punch measured 8½″ for all 8½″×11″ size paper; and 9¼ for all folders (folders should be punched so that the spine is against the right angle of the two-hole punch measure); and 7″ for most lined paper (sometimes it is best to gauge the middle of the page by equally aligning the two red margins). The file folders were labeled on the front and on the tab with the following information: course name, Days per week, time, professor's name, building name, room number, and course number. The left inside region of the file folder was labeled with “Place items from professor here, and Syllabus on top.” One of the 2 prong fasteners was attached to the left inside region to hold papers from the professor and the syllabus. The paper was labeled with this header: Day/Date and No. of Pages. The note taking paper was placed in right inside region using the 2 prong (51 mm) fastener.

The course management system was also made from a plastic folder milled twice as strongly as the plastic folders normally sold, complete with a tab, without pockets, and with a single projecting tab measuring 1″ inch high and 4″ long located at the left side, the middle, and the right side of the opening of the folder, located away from the spine of the folder. Both sides of the folder have ¼″ diameter holes located 2¾″ apart, 7/16″ from the top of the folder. The ¼″ diameter holes were located (from left/spine to right/opening) at 3¼″ and at 6″. The plastic folder was 9½″ wide (from spine to opening), and 11¾″ long (from top to bottom). 8½″×11″ notebook or note taking paper was pre-punched at ½″ from top, 2¾″ apart, and 2⅞″ and at 5⅝″ (from left to right), and preprinted with the header: Day/Date and No. of Pages. All measurements involving holes are measured to center, or center to center. The file has a spine measuring ½″ or 1″ wide running the full length of the folder.

Labeling

The tab portion of each folder, or the face of the folder in cases when the folders do not have a tab, are marked in accordance with the instructions listed below:

Course Title DY(s) Per Week, Time

Professor's Name Course No. Building Name., Room. No.

For Example, a label can look like this:

Course Title: Biology, 101 DY(s) Per Week: MWF, 10:30 a.m.

Prof: Dr. Livingston Course No: 98754321A Bldg./Rm: Wheetley Hall, 403

Sides/Filing

In this embodiment, the left side of the file is dedicated to everything that the professor gives you with the syllabus being the top most document. The right side of the file is dedicated to the student and his/her note taking.

Note Taking:

Note taking involves taking notes and creating a log in one document. The note taking procedure involves the student recording the day, date, or both, and the number of pages of notes, along with the actual notes. Even if the student does not take notes for a class, the student creates a log on the note taking paper each and every day. When notes spill onto another page the same practice still applies, the only thing different is the page number from 1 to 2, and so forth. The day, date, and page number should still be continued for each and every class—daily, if necessary.

An example of entries is as follows:

******

(First Page)

(DAY/DATE) (PAGE NUMBER)

MO/05-01 1

TU/05-02 1

WE/05-03 1

1

A. Mexican War

a. While captive, Mexican President and General Santa Anna agreed to the independence of Texas, but the Mexican government still believed that the concession was made under duress. The Mexican government further believed that Texas was still a part of Mexico.

I. Border disputes (US=Rio Grande River, MX=Nueces River).

ii. President James Polk offered Mexico $5 million for New Mexico and $25 million dollars for California. The Mexican government refused the offers.

b. President Polk decided to fight and he sent General Zachary Taylor to Texas. The Mexican and the U. S. troops clashed at the Rio Grande River.

c. May 13, 1846 President Polk declared war on Mexico.

I. General Zachary Taylor (Robert E. Lee & Ulysses S. Grant fought together under his leadership)

ii. General Winfield Scott—attacked Vera Cruz and captured Mexico City

(Second Page)

WE/05-03 2

d. Treaty of Guadalupe Hidalgo (1848)

I. The Mexican Cession. Mexico gives up a lot of land and withdrew all claims to Texas. The United States gave the Mexican government $15 million dollars and gained nearly half of Mexico's territory to include: Texas, California, Nevada, and Utah; most of Arizona; and parts of New Mexico, Colorado, and Wyoming. In 1853 the United States offered Mexico $10 million dollars for the southern sections of present-day New Mexico and Arizona which was called the Gadsden Purchase.

FR/03-27 1

MO/03-31 1

TU/04-01 1

******

The system of the present invention has also been designed to accommodate student's unique circumstances or for a person with special needs. A Vocabulary Section was created by two-hole punching a standard, tabbed insertable divider. A new section can also, or additionally, be divided to accommodate Questions, Homework Assignments, etc.

The relevant teachings of all the references, patents and/or patent applications cited herein are incorporated herein by reference in their entirety.

While this invention has been particularly shown and described with references to preferred embodiments thereof, it will be understood by those skilled in the art that various changes in form and details may be made therein without departing from the scope of the invention encompassed by the appended claims.

What is claimed is:

1. A course management system that comprises:
a file folder, when open, having a first side and a second side, wherein the first and second sides each have an inside region, an outside region, a top and a bottom;
a first fastener attached to the inside region of the first side of the file folder;
a second fastener attached to the inside region of the second side of the file folder;
a first label having a first identifier to specifically identify the course, wherein the first label is attached to the file folder;
a second label on the inside region of the first side of the folder to indicate a location of papers received from the professor; and
note taking paper, wherein the paper is marked with a header that indicates the day, date, page number, or combination thereof.

2. The course management system of claim 1, wherein the first identifier comprises the course title, name of professor, course number, class time, class location, or combination thereof.

3. The course management system of claim 1, wherein the inside region of the first side of the folder further comprises an additional label to mark a location for a course syllabus.

4. The course management system of claim 1, wherein the first fastener is located at the top of the inside region of the first side of the file folder.

5. The course management system of claim 1, wherein the second fastener is located at the top of the inside region of the second side of the file folder.

6. The course management system of claim 1, that further comprises one or more sections for vocabulary, questions, home work assignments, miscellaneous, or any combination thereof.

7. The course management system of claim 1, further including at least one tab.

8. The course management system of claim 7, wherein the first label is placed on the tab.

9. The course management system of claim 1, wherein the first label placed on the front of the file folder.

10. The course management system of claim 1, the further comprises a pocket for receiving a course syllabus, wherein the pocket is attached to the inside of the first side of the file folder.

11. The course management system of claim 10, wherein the pocket is transparent.

12. The course management system of claim 1, the further comprises a two hole punch.

13. A file folder for use in managing a course, said file folder comprises: when open, a first side and a second side, wherein the first and second sides each have an inside region, an outside region, a top and a bottom,
a first fastener attached to the inside region of the first side of the file folder;
a second fastener attached to the inside region of the second side of the file folder;
a first label having a first identifier to specifically identify the course, wherein the first label is attached to the file folder;
a second label on the inside region of the first side of the folder to indicate a location of papers received from the professor; and
a third label on the inside region of the second side of the folder to mark a location of note taking paper.

14. Note taking paper that comprises:
paper being a suitable size for taking notes; and
a header positioned at the top of the paper that indicates the day, date, page number, or combination thereof.

15. A method for using a course management system, wherein the method comprises:
obtaining the course management system of claim 1;
taking notes on the note taking paper by recording the day, date or both, number of pages, and notes, if any; and
attaching papers received from a professor from the course with the first fastener.

16. The method of claim 15, the method further includes attaching the syllabus to the first fastener on top of papers received from the professor.

17. A method of making a course management system, the method comprises:
marking or labeling a filed folder with a first identifier for the course, wherein the file folder, when open, has a first side and a second side, and the first and second sides each have an inside region and outside region;
attaching a first fastener to the inside region of the first side of the file folder;
attaching a second fastener to the inside region of the second side of the file folder;
marking or labeling the file folder with a second label on the inside region of the first side of the folder to indicate a location of papers received from the professor; and
attaching note taking paper with the second fastener, wherein the paper is marked with a header that indicates the day, date, page number, or combination thereof.

18. The method of claim 17, further including inserting, into the file folder, one or more dividers.

19. The method of claim 18, wherein the dividers are marked for use for vocabulary, questions, home work assignments, science course labs, registration information, financial aid information, or combination thereof.

20. The method of claim 16, wherein labeling a filed folder with the first identifier for the course includes identifying the course title, name of professor, course number, class time and class location includes labeling said identifiers.
